(19) United States
(12) Patent Application Publication
(10) Pub. No.: US 2008/0227015 A1
(43) Pub. Date: Sep. 18, 2008

(54) TONER FOR DEVELOPING ELECTROSTATIC LATENT IMAGE, TONER CONTAINER, DEVELOPER, IMAGE FORMING APPARATUS, PROCESS CARTRIDGE AND METHOD OF PREPARING THE TONER

(76) Inventors: Tsuneyasu NAGATOMO, Numazu-shi (JP); Toyoshi Sawada, Hiratsuka-shi (JP); Takuya Seshita, Hiratsuka-shi (JP); Satoshi Kojima, Numazu-shi (JP); Tomomi Suzuki, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/035,862

(22) Filed: Feb. 22, 2008

(30) Foreign Application Priority Data
Mar. 16, 2007 (JP) 2007-069424

(51) Int. Cl. G03G 9/087; G03G 15/00

(52) U.S. Cl. 430/109.4; 399/2

(57) ABSTRACT

A toner, including at least a binder resin; a colorant; and a modified layered inorganic mineral in which at least a part of ions between the layers are modified with an organic material ion, wherein the toner includes at least one external additive having an average primary particle diameter of from 80 to 180 nm and an aspect ratio of from 0.7 to 0.95.

### BACKGROUND OF THE INVENTION

1. Field of the Invention

The present invention relates to a toner for use in a developer for developing an electrostatic latent image in electrophotography, electrostatic recording, electrostatic printing, etc., and to an image forming apparatus using the toner. More particularly to a toner for developing an electrostatic image for use in copiers, laser printers, plain paper facsimiles, etc. using direct or indirect electrophotographic developing method, a toner container, a developer, an image forming apparatus, a process cartridge including the toner, and to a method of preparing the toner.

2. Discussion of the Background

For example, an image bearer is charged and irradiated to form an electrostatic latent image thereon, and the an electrostatic latent image is developed with a developer including a toner to form a toner image thereon. Further, the toner image is transferred onto a recording material and fixed thereon. On the other hand, atoner remaining untransferred on the image bearer is cleaned by a cleaning member such as a blade pressed to the surface of the image bearer.

A pulverization method is known as a method of preparing a toner. The pulverization method includes melting and kneading constituents including a thermoplastic binder resin, a colorant and optional additives to prepare a kneaded mixture; and pulverizing and classifying the kneaded mixture. However, a toner prepared thereby has a large particle diameter and is difficult to produce high-quality images.

A toner is also prepared by a polymerization method or an emulsion dispersion method. The polymerization method includes a suspension polymerization method of adding a monomer, a polymerization initiator, a colorant, a charge control agent, etc. into an aqueous medium including a dispersant while stirring to form an oil drop. In addition, an association method of agglutinating and fusion bonding particles prepared by the emulsion polymerization or suspension polymerization method.

However, although these methods can prepare a toner having a small particle diameter, they limit to a radical polymerized binder resin and cannot prepare a polyester resin or an epoxy resin preferably used for a color toner.

Japanese published unexamined patent applications Nos. 5-66600 and 8-211655 disclose the emulsion dispersion method of mixing a mixture of a binder resin, a colorant, etc. with an aqueous medium to prepare an emulsion. This method can prepare a toner having a small particle diameter and widen a range of choice of the binder resin. However, this method generates fine particles and causes an emulsion loss.

Japanese published unexamined patent applications Nos. 10-20522 and 11-7156 disclose a method of emulsion-dispersing a polyester resin to prepare particles and agglutinating and fusion-bonding the particles to prepare a toner. This method prevents fine particles from be generated and reduces the emulsion loss.

However, a toner prepared by the polymerization method or emulsion dispersion method is likely to have the shape of a sphere due to a surface tension of a droplet generated in the dispersion process. Therefore, when a blade cleaning method is used, a spherical toner rotates between the cleaning blade and a photoreceptor and is difficult to clean.

Japanese published unexamined patent application No. 62-266550 discloses a method of applying a mechanical force to particles to be amorphous while stirring them at a high speed before finishing polymerization. However, this method destabilizes the dispersion status of the particles and they are likely to be in union each other.

Japanese published unexamined patent application No. 2-51164 discloses a method of agglutinating particles using polyvinylalcohol having a specific saponification as a dispersant to prepare associated particles having a particle diameter of from 5 to 25 μm. However, the associated particles prepared thereby are likely to have a large particle diameter.

Japanese published unexamined patent application No. 2005-49858 discloses a method of adding a filler with toner constituents such that the resultant toner particles become amorphous. However, when a toner includes a filler, the viscoelasticity thereof increases, resulting in deterioration of the low-temperature fixability. When the filler is present at the surface of the toner, the viscoelasticity of thereof scarcely increases, but the filler prevents a wax from exuding and the binder resin from melting, resulting in deterioration of the low-temperature fixability and hot offset resistance.

Further, WO01/040878, WO2004/019137, WO2004/019138 and Japanese published unexamined patent application No. 2003-202708 disclose using a modified layered inorganic mineral wherein a metallic cation present between the layers thereof is modified with an organic cation as a charge controlling agent in a toner.

However, the modified layered inorganic mineral becomes miniaturized and deformed while preparing a toner, and many of them are particularly present at the surface of the toner particles, resulting in surface concavities and convexities thereof. Although the toner can be cleaned with a blade, large external additives gather in concavities, resulting in deterioration of the transferability.

Because of these reasons, a need exists for a toner having good transferability, good low-temperature fixability and less untransferred toner, and producing high-quality images.

### SUMMARY OF THE INVENTION

Accordingly, an object of the present invention is to provide a toner having good transferability, good low-temperature fixability and less untransferred toner, and producing high-quality images.

Another object of the present invention is to provide an image forming apparatus using the toner.

A further object of the present invention is to provide a toner container containing the toner.

Another object of the present invention is to provide a developer including the toner.

A further object of the present invention is to provide a process cartridge using the toner.

Another object of the present invention is to provide a method of preparing the toner.

These objects and other objects of the present invention, either individually or collectively, have been satisfied by the discovery of a toner, comprising:

a binder resin;

a colorant; and

a modified layered inorganic mineral in which at least a part of ions between the layers are modified with an organic material ion,

wherein the toner comprises at least one external additive having an average primary particle diameter of from 80 to 180 nm and an aspect ratio of from 0.7 to 0.95.

### DETAILED DESCRIPTION OF THE INVENTION

The present invention provides a toner having good transferability, good low-temperature fixability and less untransferred toner, and producing high-quality images. More particularly, the present invention relates to a toner, comprising:

a binder resin;

a colorant; and

a modified layered inorganic mineral in which at least a part of ions between the layers are modified with an organic material ion,

wherein the toner comprises at least one external additive having an average primary particle diameter of from 80 to 180 nm and an aspect ratio of from 0.7 to 0.95.

First, the layered inorganic mineral in which at least a part of ions between the layers are modified with an organic material ion of the present invention will be explained.

The layered inorganic mineral is an inorganic mineral including overlapped layers having a thickness of some nm respectively. Modifying with an organic material ion means introducing an organic material ion into an ion present between the layers, which is specifically disclosed in WO01/040878, WO2004/019137 and WO2004/019138. This is broadly called an “intercalation”. The layered inorganic minerals include a smectite group such as montmorillonite and saponite; a kaolin group such as kaolinite; magadiite; and kanemite. The modified layered inorganic mineral has high hydrophilicity because of its modified layered structure. Therefore, when the layered inorganic mineral is dispersed without being modified in an aqueous medium to granulate a toner, the layered inorganic mineral passes into the aqueous medium and the toner is not deformed. The modified layered inorganic mineral miniaturizes and deforms a toner when granulating the toner, and is present much particularly at the surface of the toner to perform charge control and contribute to the low-temperature fixability. The toner constituents preferably include the modified layered inorganic mineral in an amount of from 0.05 to 5% by weight.

The modified layered inorganic mineral for use in the present invention is preferably a mineral having a basic smectite crystal structure, which is modified with an organic cation. A part of the bivalent metal of the layered inorganic mineral can be substituted with a trivalent metal to form a metal anion. However, the metal anion has high hydrophilicity and a part thereof is preferably modified with an organic anion.

The organic material ion modifier includes a quaternary alkyl ammonium salt, a phosphonium salt, an imidazolium salt, etc., and the quaternary alkyl ammonium salt is preferably used. Specific examples thereof include trimethylstearylammonium, dimethylstearylbenzylammonium, dimethyloctadecylammonium, oleylbis(2-hydroxylethyl)methylammonium, etc.

The organic material ion modifier further includes sulfate salts having a branched, unbranched or cyclic alkyl group having 1 to 44 carbon atoms, an alkenyl group having 1 to 22 carbon atoms, an alkoxy group having 8 to 32 carbon atoms, a hydroxyalkyl group having 2b to 22 carbon atoms, an ethylene oxide, a propylene oxide, etc.; salts of sulfonic acid; salts of carboxylic acid; or salts of phosphoric acid. A carboxylic acid having an ethylene oxide skeleton is preferably used.

The (modified) layered inorganic mineral partially modified with an organic material ion has appropriate hydrophobicity, and an oil phase including toner constituents and/or a toner constituents precursor has a non-Newtonian viscosity and the resultant toner can be deformed. The toner constituents preferably include the layered inorganic mineral partially modified with an organic material ion in an amount of from 0.05 to 5% by weight.

Specific examples of the (modified)layered inorganic mineral partially modified with an organic material ion include montmorillonite, bentonite, hectolite, attapulgite, sepiolite, their mixtures, etc. Particularly, the organic-modified montmorillonite and bentonite are preferably used because they do not influence upon the resultant toner properties, the viscosity thereof can easily be controlled and a small content thereof works.

Specific examples of marketed products of the layered inorganic mineral partially modified with an organic material cation include Quartanium 18 Bentonite such as Bentone 3, Bentone 38, Bentone 38V, Tixogel VP, Clayton 34, Clayton 40 and Clayton XL; Stearalkonium Bentonite such as Bentone 27, Tixogel LG, Clayton AF and Clayton APA; and Quartanium 18/Benzalkonium Bentonite such as Clayton HT and Clayton PS. Particularly, Clayton AF and Clayton APA are preferably used. In addition, DHT-4A from Kyowa Chemical Industry, Co., Ltd., which is modified with an organic anion having the following formula (1) is preferably used as the layered inorganic mineral partially modified with an organic anion. Specific examples of the organic anion having the following formula (1) include Hitenol 3330T from Dai-ichi Kogyo Seiyaku Co., Ltd.

R₁ (OR₂)ₙOSO₃M (1)w

wherein R1 represents an alkyl group having 13 carbon atoms; R₂ represents an alkylene group having 2 to 6 carbon atoms; n represents an integer of from 2 to 10; and M represents a monovalent metallic element.

The modified layered inorganic mineral has appropriate hydrophobicity, and an oil phase including toner constituents has a non-Newtonian viscosity and the resultant toner can be deformed.

However, the modified layered inorganic mineral becomes miniaturized and deformed while preparing a toner, and many of them are particularly present at the surface of the toner particles, resulting in surface concavities and convexities thereof. Although the toner can be cleaned with a blade, large external additives gather in concavities, resulting in deterioration of the transferability.

Therefore, an external additive having an average primary particle diameter of from 80 to 180 nm and an aspect ratio of from 0.7 to 0.95 is used to largely improve the transferability. The external additive more preferably has an average primary particle diameter of from 90 to 150 nm and an aspect ratio of from 0.8 to 0.9.

The method of preparing the toner of the present invention includes applying an external additive to the surface of a particulate parent toner.

In the present invention, even when comparatively a large external additive having an average primary particle diameter of from 80 to 180 nm is applied to the toner including a layered inorganic mineral in which at least a part of ions between the layers are modified with an organic material ion, the external additive can uniformly be applied to the surface thereof without clustering in the concavities thereof if the external additive has an aspect ratio of from 0.7 to 0.95.

The external additive includes an inorganic particulate material and an organic particulate material. At least one external additive is preferably included in the toner, and 2 to 3 external additives are more preferably included therein.

The inorganic particulate material can be used as an external additive to impart the fluidity and developability and chargeability of a toner.

Specific examples of the inorganic particulate material include silica, titanium oxide, alumina, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc. Particularly, silica, titanium oxide and alumina are preferably used, and silica is more preferably used. These inorganic particulate materials can be used alone or in combination.

The inorganic particulate material preferably has a primary particle diameter of from 5 nm to 2 μm, and more preferably from 5 nm to 500 nm. In addition, the inorganic particulate material preferably has a specific surface area of from 20 to 500 m²/g when measured by BET method.

A toner preferably includes the inorganic particulate material in an amount of from 0.01 to 5% by weight, and more preferably from 0.01 to 2.0% by weight.

A fluidity improver for use in the present invention is a surface treatment agent to increase the hydrophobicity of a toner to prevent deterioration of fluidity and chargeability thereof even in an environment of high humidity. Specific examples thereof include a silane coupling agent, a sililating agent, a silane coupling agent having an alkyl fluoride group, an organic titanate coupling agent, an aluminium coupling agent a silicone oil and a modified silicone oil.

A cleanability improver for use in the present invention is added to remove a developer remaining on a photoreceptor and a first transfer medium after transferred. Specific examples of the cleanability improver include fatty acid metallic salts such as zinc stearate, calcium stearate and stearic acid; and polymer particles prepared by a soap-free emulsifying polymerization method such as polymethyl methacrylate particles and polystyrene particles. The polymer particles comparatively have a narrow particle diameter distribution and preferably have a volume-average particle diameter of from 0.01 to 1 μm.

Specific examples of the organic particulate material include polystyrene formed by a soap-free emulsion polymerization, a suspension polymerization or a dispersion polymerization; ester methacrylate or ester acrylate copolymer; silicone; benzoguanamine; polycondensated products such as nylon; polymeric particulate materials formed of thermosetting resins; etc.

The inorganic or organic particulate materials as an external additive having an average primary particle diameter of from 80 to 180 nm preferably has an aspect ratio of from 0.7 to 0.95, and more preferably from 0.8 to 0.9. The aspect ratio is measured by observing a single particle with a SEM or a TEM.

A minor axis is divided by a major axis of the external additive to determine the aspect ratio thereof.

Aspect ratio=minor axis/major axis

The external additive is mixed with the toner such that the external additive adheres to the surface thereof. Next, coarse particles and agglomerated particles are removed with a sieve having 250 meshes or more.

The toner of the present invention preferably has an average circularity of from 0.925 to 0.970, and more preferably from 0.945 to 0.965. A peripheral length of a circle having an area equivalent to that of a projected image optically detected is divided by an actual peripheral length of the toner particle to determine the circularity of a toner. The toner preferably includes particles having a circularity less than 0.925 in an amount not greater than 15%. A toner having an average circularity less than 0.925 is likely not to have a satisfactory transferability and produce high-quality images without scattering. When the toner has an average circularity greater than 0.970, a photoreceptor and a transfer belt in an apparatus using a cleaning blade are poorly cleaned, resulting in occasional production of contaminated images. When an image having a large image area, an untransferred residual toner due to defective paper feeding is accumulated on the photoreceptor, resulting in production of images having background fouling. Further, a contact charger such as a charging roller charging a photoreceptor while contacting thereto is contaminated, resulting in having poor chargeability.

The average circularity of the toner is suitably measured by an optical detection method of passing a suspension liquid including a particle through a plate-shaped imaging detector to detect and analyze an image of the particle with a CCD camera. Specifically, a flow-type particle image analyzer FPIA-2000 from SYSMEX CORPORATION can be used.

The toner of the present invention preferably has a ratio (Dv/Dn) of a volume-average particle diameter (Dv) thereof to a number-average particle diameter thereof (Dn) of from 1.10 to 1.30 to produce high-resolution and high-quality images. Further, in a two-component developer, the toner has less variation in the particle diameter even after consumed and fed for long periods, and has good and stable developability even after stirred in an image developer for long periods. When Dv/Dn is greater than 1.30, the particle diameter distribution of the toner becomes flat, resulting in deterioration of reproducibility of a microscopic dot. The toner more preferably has Dv/Dn of from 1.00 to 1.20 to produce better quality images.

The toner of the present invention preferably has a volume-average particle diameter (Dv) of from 3.0 to 7.0 μm. Typically, it is said that the smaller the toner particle diameter, the more advantageous to produce high resolution and quality images. However, the small particle diameter of the toner is disadvantageous thereto to have transferability and cleanability. When the volume-average particle diameter is too small, the resultant toner in a two-component developer melts and adheres to a surface of a carrier to deteriorate chargeability thereof when stirred for long periods in an image developer. When the toner is used in a one-component developer, toner filming over a developing roller and fusion bond of the toner to a blade forming a thin layer thereof tend to occur. This largely depends on a content of a fine powder. When the toner includes particles having a diameter not greater than 2 μm in an amount greater than 20% by number, the toner is likely to adhere to a carrier and have poor charge stability. When the average particle diameter is larger than the scope of the present invention, the resultant toner has a difficulty in producing high resolution and quality images. In addition, the resultant toner has a large variation of the particle diameters in many cases after the toner in a developer is consumed and fed for long periods. When Dv/Dn is greater than 1.30, the results are same.

As mentioned above, the toner preferably includes particles having a circularity not greater than 0.950 in an amount of from 20 to 80% by number because toner particles having a uniform and small particle diameter are difficult to clean.

A relationship between the shape and transferability of a toner will be explained. Only a conventional amorphous toner is difficult to improve the transferability in a full-color copier where in multicolor development and transfer are performed is because an amount of the toner on a photoreceptor increases compared with a unicolor black toner for used in a monochrome copier. Further, when a conventional toner is used, toner is likely to be fusion-bonded to or filming over the surface of a photoreceptor or an intermediate transferer due to scrapes or frictions between a photoreceptor and a cleaning member, an intermediate transferer and a cleaning member and/or a photoreceptor and an intermediate transferer, resulting in deterioration of the transferability. Four color toner images are difficult to uniformly transfer in full-color image formation. Further, when an intermediate transferer is used, color uniformity and balance are likely to have problems and high-quality full-color images are not easy to stably produce.

A toner including particles having a circularity not greater than 0.950 in an amount of from 20 to 80% by number has both good blade cleanability and transferability. The blade cleaning and transferability largely depends on a material of the blade and how to contact the blade to a photoreceptor as well. When the toner includes particles having a circularity not greater than 0.950 in an amount less than 20% by number, the blade cleaning becomes difficult. When the toner includes particles having a circularity not greater than 0.950 in an amount greater than 80% by number, the transferability deteriorates. This is because the toner is so deformed that the toner does not smoothly transfer between the surface of a photoreceptor and a transfer paper, the surface of a photoreceptor and an intermediate transferer, a first intermediate transferer and a second intermediate transferer, etc., and toner particles unevenly transfer, resulting in nonuniform and low transferability. Besides, the toner is unstably charged and fragile. Further, the toner becomes a fine powder in a developer, resulting in deterioration of durability of the developer.

The content of the toner particles having a diameter not greater than 2 μm and the circularity of the toner is measured by a flow-type particle image analyzer FPIA-2000 from SYSMEX CORPORATION. A specific measuring method includes adding 0.1 to 0.5 ml of a surfactant, preferably an alkylbenzenesulfonic acid, as a dispersant in 100 to 150 ml of water from which impure solid materials are previously removed; adding 0.1 to 0.5 g of the toner in the mixture; dispersing the mixture including the toner with an ultrasonic disperser for 1 to 3 min to prepare a dispersion liquid having a concentration of from 3,000 to 10,000 pieces/μl; and measuring the toner shape and distribution with the above-mentioned measurer.

The average particle diameter and particle diameter distribution of the toner can be measured by a Coulter counter TA-II or Coulter Multisizer II from Beckman Coulter, Inc. as follows:

0.1 to 5 ml of a detergent, preferably alkylbenzene sulfonate is included as a dispersant in 100 to 150 ml of the electrolyte ISOTON R-II from Coulter Scientific Japan, Ltd., which is a NaCl aqueous solution including an elemental sodium content of 1%;

2 to 20 mg of a toner sample is included in the electrolyte to be suspended therein, and the suspended toner is dispersed by an ultrasonic disperser for about 1 to 3 min to prepare a sample dispersion liquid; and

a volume and a number of the toner particles for each of the following channels are measured by the above-mentioned measurer using an aperture of 100 μm to determine a weight distribution and a number distribution:

2.00 to 2.52 μm; 2.52 to 3.17 μm; 3.17 to 4.00 μm; 4.00 to 5.04 μm; 5.04 to 6.35 μm; 6.35 to 8.00 μm; 8.00 to 10.08 μm; 10.08 to 12.70 μm; 12.70 to 16.00 μm; 16.00 to 20.20 μm; 20.20 to 25.40 μm; 25.40 to 32.00 μm; and 32.00 to 40.30 μm.

In the present invention, an Interface producing a number distribution and a volume distribution from Nikkaki Bios Co., Ltd. and a personal computer PC9801 from NEC Corp. are connected with the Coulter Multisizer II to measure the average particle diameter and particle diameter distribution.

Further in the present invention, THF-soluble components of a polyester resin included in the binder resin preferably have a weight-average molecular weight of from 1,000 to 30,000 to prepare a toner maintaining heat-resistant preservability, effectively exerting low-temperature fixability and having offset resistance. When less than 1,000, the heat-resistant preservability deteriorates because an oligomer components increase. When greater than 30,000, the offset resistance deteriorates because the polyester resin is not sufficiently modified due to a steric hindrance.

In the present invention, molecular weight is measured by GPC (gel permeation chromatography) as follows. A column is stabilized in a heat chamber having a temperature of 40° C.; THF is put into the column at a speed of 1 ml/min as a solvent; 50 to 200 μl of a THF liquid-solution of a resin, having a sample concentration of from 0.05 to 0.6% by weight, is put into the column; and a molecular weight distribution of the sample is determined by using a calibration curve which is previously prepared using several polystyrene standard samples having a single distribution peak, and which shows the relationship between a count number and the molecular weight. As the standard polystyrene samples for making the calibration curve, for example, the samples having a molecular weight of 6×10², 2.1×10³, 4×10³, 1.75×10⁴, 5.1×10⁴, 1.1×10⁵, 3.9×10⁵, 8.6×10⁵, 2×10⁶ and 48×10⁶ from Pressure Chemical Co. or Tosoh Corporation are used. It is preferable to use at least 10 standard polystyrene samples. In addition, an RI (refraction index) detector is used as the detector.

A first binder resin in the toner of the present invention is preferably a resin having a polyester skeleton, specifically a polyester resin. When the first binder resin has an acid value of from 1.0 to 50.0 KOH mg/g, a basic compound is capably added to the toner to enhance the toner properties such as particle diameter controllability, low-temperature fixability, hot offset resistance, heat-resistant preservability and charge stability. Namely, when the acid value is greater than 50.0 KOH mg/g, an elongation or across-linking reaction of the binder resin precursor insufficiently performed, resulting in poor hot offset resistance. When less than 1.0 KOH mg/g, a basic compound does not stabilize the dispersion of the binder resin and an elongation or a cross-linking reaction of a modified polyester is likely to perform, i.e., the toner is not stably prepared.

The acid value of the resin is measured by the method mentioned in JIS K0070-1992.

0.5 g of polyester is stirred in 120 ml of THF at a room temperature (23° C.) for 10 hrs to be dissolved therein, and 30 ml of ethanol is further added thereto to prepare a sample solution.

The following device is used to measure the acid value, and which is specifically determined as follows.

A N/10 caustic potassium-alcohol solution is titrated in the sample solution and the acid value is determined form a consumed amount of the caustic potassium-alcohol solution using the following formula:

Acid value=KOH (ml)×N×56.1/weight of the sample solution wherein N is N/10 KOH factor.

The acid value of the polyester resin for use in the present invention is measured by the following method based on JIS K0070, using a mixed a solvent including 120 ml of toluene and 30 ml of ethanol.

The acid value is specifically decided by the following procedure.

Measurer: potentiometric automatic titrator
DL-53 Titrator from Metler-Toledo Limited

Electrode: DG113-SC from Metler-Toledo Limited

Analysis software: LabX Light Version 1.00.000

Temperature: 23° C.

The measurement conditions are as follows:

Stir

| | |
|---|---|
| Speed[%] | 25 |
| Time[s] | 15 |

EQP titration
Titrant/Sensot

| | |
|---|---|
| Titrant | CH30Na |
| Concentration[mol/L] | 0.1 |
| Sensor | DG115 |
| Unit of measurement | mV |

Predispensing to volume

| | |
|---|---|
| Volume [ml] | 1.0 |
| Wait time [s] | 0 |

| Titrant addition | Dynamic |
|---|---|
| dE(set) [mV] | 8.0 |
| dV(min) [mL] | 0.03 |
| dV(max) [mL] | 0.5 |

| Measure mode | Equilibrium controlled |
|---|---|
| dE [mV] | 0.5 |
| dt [s] | 1.0 |
| t(min) [s] | 2.0 |
| t(max) [s] | 20.0 |

Recognition

| | |
|---|---|
| Threshold | 100.0 |
| Steepest jump only | No |
| Range | No |
| Tendency | None |

Termination

| | |
|---|---|
| at maximum volume [mL] | 10.0 |
| at potential | No |
| at slope | No |
| after number EQPs | Yes |
| n = 1 | |
| comb. Termination conditions | No |

Evaluation

| | |
|---|---|
| Procedure | Standard |
| Potential 1 | No |
| Potential 2 | No |
| Step for reevaluation | No |

In the present invention, heat-resistant preservability of main components of a polyester resin after modified, i.e., a binder resin depends on a glass transition temperature of the polyester resin before modified, and a first binder resin preferably has a glass transition temperature of from 35 to 65° C. When less than 35° C., the heat-resistant preservability is insufficient. When greater than 65° C., the low-temperature fixability deteriorates.

In the present invention, the glass transition temperature (Tg) is measured by TG-DSC system TAS-100 from RIGAKU Corp. at a programming rate of 10° C./min.

First, about 10 mg of a sample in an aluminum container was loaded on a holder unit, which was set in an electric oven. After the sample was heated in the oven at from a room temperature to 150° C. and a programming speed of 10° C./min, the sample was left for 10 min at 150° C. After the samples was cooled to have a room temperature and left for 10 min, the sample was heated again in a nitrogen environment to have a temperature of 150° C. at a programming speed of 10° C./min and DSC measurement of the sample was performed. Tg was determined from a contact point between a tangent of a heat absorption curve close to Tg and base line using an analyzer in TAS-100.

In the present invention, the binder resin precursor resin is essential to realize low-temperature fixability and hot offset resistance of the resultant toner, and preferably has a weight-average molecular weight of from 3,000 to 20,000. When less than 3,000, the reaction speed is difficult to control and the production stability deteriorates. When greater than 20,000, a polyester sufficiently modified cannot be obtained and offset resistance of the resultant toner deteriorates.

In the present invention, an acid value of a toner is more essential index than that of a binder resin for low-temperature fixability and hot offset resistance of the resultant toner. An acid value of the toner of the present invention comes from an end carboxyl group of an unmodified polyester resin. The toner preferably has an acid value of form 0.5 to 40.0 (KOH mg/g) to control low-temperature fixability such as minimum fixable temperature and hot offset generation temperature of the resultant toner. When greater than 40.0 (mg KOH/g), an elongation or a cross-linking reaction of a modified polyester is not sufficient and the hot offset resistance of the resultant toner deteriorates. When less than 0.5 (mg KOH/g), a basic compound does not stabilize the dispersion of the binder resin and an elongation or a cross-linking reaction of a modified polyester is likely to perform, i.e., the toner is not stably prepared.

The acid value of the toner is specifically determined according to the method of measuring the acid value of the polyester resin. When the toner includes THF-insoluble components, the acid value thereof is measured using THF as a solvent.

The acid value of the toner is measured by the method mentioned in JIS K0070-1992, using 0.5 g (0.3 g when ethylacetate-soluble components are included in the toner) of the toner instead of the polyester resin.

The toner of the present invention preferably has a glass transition temperature of from 40 to 70° C. to have low-temperature fixability, high-temperature offset resistance and high durability. When less than 40° C., toner blocking in an image developer and filming over a photoreceptor tend to occur. When greater than 70° C., the low-temperature fixability of the resultant toner deteriorates.

The toner of the present invention is preferably prepared by dispersing and/or emulsifying toner constituents including the modified layered inorganic mineral in an aqueous medium. Specifically, the toner is preferably prepared by dissolving or dispersing toner constituents including at least a first binder resin, a binder resin precursor, a compound elongating or crosslinking with the binder resin precursor, a colorant, a release agent and the modified layered inorganic mineral in an organic solvent to prepare a solution or a dispersion; crosslinking and/or elongating the solution or dispersion in an aqueous medium to prepare a dispersion; and removing the solvent from the dispersion.

A reactive modified polyester resin reactable with an active hydrogen (RMPE) is preferably used as the binder resin precursor for use in the present invention. Specific examples thereof (RMPE) include a polyester polymer (A) having an isocyanate group. Specific examples of the prepolymer (A) include a polymer formed from a reaction between polyester having an active hydrogen atom formed by polycondensation between polyol (PO) and a polycarboxylic acid, and polyisocyanate (PIC). Specific examples of the groups including the active hydrogen include a hydroxyl group (an alcoholic hydroxyl group and a phenolic hydroxyl group), an amino group, a carboxyl group, a mercapto group, etc. In particular, the alcoholic hydroxyl group is preferably used.

Amines are used as a crosslinker for the reactive modified polyester resin, and diisocyanate compounds such as diphenylmethanediisocyanate are used as an elongator therefor. The amines mentioned in detail later work as a crosslinker or an elongator for the modified polyester resin reactable with an active hydrogen.

The modified polyester such as a urea-modified polyester formed from a reaction between the polyester prepolymer having an isocyanate group (A) and an amine (B) is easy to control molecular weight of the high molecular weight component, and preferably used for an oilless low-temperature fixing method (without an release oil applicator for a heating medium for fixation). Particularly, the polyester prepolymer having a urea-modified end can prevent adherence to the heating medium for fixation while maintaining high fluidity and transparency of an unmodified polyester resin in a range of fixing temperature.

The polyester prepolymer for use in the present invention is preferably a polyester having at its end an acid radical or a hydroxyl group including an active hydrogen to which a functional group such as an isocyanate group is introduced. A modified polyester such as a urea-modified polyester can be introduced from the prepolymer. However, in the present invention, the modified polyester used as a toner binder is preferably a urea-modified polyester formed from a reaction between the polyester prepolymer having an isocyanate group (A) and the amine (B) used as a crosslinker and/or an elongation agent. The polyester prepolymer (A) can be formed from a reaction between polyester having an active hydrogen atom formed by polycondensation between polyol (PO) and a polycarboxylic acid, and polyisocyanate (PIC). Specific examples of the groups including the active hydrogen include a hydroxyl group (an alcoholic hydroxyl group and a phenolic hydroxyl group), an amino group, a carboxyl group, a mercapto group, etc. In particular, the alcoholic hydroxyl group is preferably used.

As the polyol (PO), diol (DIO) and polyol having 3 valences or more (TO) can be used, and DIO alone or a mixture of DIO and a small amount of TO is preferably used. Specific examples of DIO include alkylene glycol such as ethylene glycol, 1,2-propylene glycol, 1,3-propylene glycol, 1,4-butanediol, and 1,6-hexanediol; alkylene ether glycol such as diethylene glycol, triethylene glycol, dipropylene glycol, polyethylene glycol, polypropylene glycol and polytetramethylene ether glycol; alicyclic diol such as 1,4-cyclohexanedimethanol and hydrogenated bisphenol A; bisphenol such as bisphenol A, bisphenol F and bisphenol S; adducts of the above-mentioned alicyclic diol with an alkylene oxide such as ethylene oxide, propylene oxide and butylene oxide; and adducts of the above-mentioned bisphenol with an alkylene oxide such as ethylene oxide, propylene oxide and butylene oxide. In particular, alkylene glycol having 2 to 12 carbon atoms and adducts of bisphenol with an alkylene oxide are preferably used, and a mixture thereof is more preferably used. Specific examples of TO include multivalent aliphatic alcohol having 3 to 8 or more valences such as glycerin, trimethylolethane, trimethylolpropane, pentaerythritol and sorbitol; phenol having 3 or more valences such as trisphenol PA, phenolnovolak, cresolnovolak; and adducts of the above-mentioned polyphenol having 3 or more valences with an alkylene oxide.

As the polycarboxylic acid (PC), dicarboxylic acid (DIC) and polycarboxylic acid having 3 or more valences (TC) can be used. DIC alone, or a mixture of DIC and a small amount of TC are preferably used. Specific examples of DIC include alkylene dicarboxylic acids such as succinic acid, adipic acid and sebacic acid; alkenylene dicarboxylic acid such as maleic acid and fumaric acid; and aromatic dicarboxylic acids such as phthalic acid, isophthalic acid, terephthalic acid and naphthalene dicarboxylic acid. In particular, alkenylene dicarboxylic acid having 4 to 20 carbon atoms and aromatic dicarboxylic acid having 8 to 20 carbon atoms are preferably used. Specific examples of TC include aromatic polycarboxylic acids having 9 to 20 carbon atoms such as trimellitic acid and pyromellitic acid. PC can be formed from a reaction between the PO and the above-mentioned acids anhydride or lower alkyl ester such as methyl ester, ethyl ester and isopropyl ester. PO and PC are mixed such that an equivalent ratio ([OH]/[COOH]) between a hydroxyl group [OH] and a carboxylic group [COOH] is typically from 2/1 to 1/1, preferably from 1.5/1 to 1/1, and more preferably from 1.3/1 to 1.02/1.

Specific examples of the PIC include aliphatic polyisocyanate such as tetramethylenediisocyanate, hexamethylenediisocyanate and 2,6-diisocyanatemethylcaproate; alicyclic polyisocyanate such as isophoronediisocyanate and cyclohexylmethanediisocyanate; aromatic diisocyanate such as tolylenedisocyanate and diphenylmethanediisocyanate; aroma aliphatic diisocyanate such as α,α,α′,α′-tetramethylxylylenediisocyanate; isocyanurate; the above-mentioned polyisocyanate blocked with phenol derivatives, oxime and caprolactam; and their combinations.

The PIC is mixed with polyester such that an equivalent ratio ([NCO]/[OH]) between an isocyanate group [NCO] and polyester having a hydroxyl group [OH] is typically from 5/1 to 1/1, preferably from 4/1 to 1.2/1 and more preferably from 2.5/1 to 1.5/1. When [NCO]/[OH] is greater than 5, low temperature fixability of the resultant toner deteriorates. When [NCO] has a molar ratio less than 1, a urea content in ester of the modified polyester decreases and hot offset resistance of the resultant toner deteriorates. The content of the constitutional component of a polyisocyanate in the polyester prepolymer (A) having a polyisocyanate group at its end portion is from 0.5 to 40% by weight, preferably from 1 to 30% by weight and more preferably from 2 to 20% by weight. When the content is less than 0.5% by weight, hot offset resistance of the resultant toner deteriorates, and in addition, the heat resistance and low temperature fixability of the toner also deteriorate. In contrast, when the content is greater than 40% by weight, low temperature fixability of the resultant toner deteriorates.

The number of the isocyanate groups included in a molecule of the polyester prepolymer (A) is at least 1, preferably from 1.5 to 3 on average, and more preferably from 1.8 to 2.5 on average. When the number of the isocyanate group is less than 1 per 1 molecule, the molecular weight of the urea-modified polyester decreases and hot offset resistance of the resultant toner deteriorates.

Specific examples of the amines (B) include diamines (B1), polyamines (B2) having three or more amino groups, amino alcohols (B3), amino mercaptans (B4), amino acids (B5) and blocked amines (B6) in which the amines (B1-B5) mentioned above are blocked. Specific examples of the diamines (B1) include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoron diamine); aliphatic diamines (e.g., ethylene diamine, tetramethylene diamine and hexamethylene diamine); etc. Specific examples of the polyamines (B2) having three or more amino groups include diethylene triamine, triethylene tetramine. Specific examples of the amino alcohols (B3) include ethanol amine and hydroxyethyl aniline. Specific examples of the amino mercaptan (B4) include aminoethyl mercaptan and aminopropyl mercaptan. Specific examples of the amino acids include amino propionic acid and amino caproic acid. Specific examples of the blocked amines (B6) include ketimine compounds which are prepared by reacting one of the amines B1-B5 mentioned above with a ketone such as acetone, methyl ethyl ketone and methyl isobutyl ketone; oxazoline compounds, etc. Among these compounds, diamines (B1) and mixtures in which a diamine is mixed with a small amount of a polyamine (B2) are preferably used.

The molecular weight of the urea-modified polyesters can optionally be controlled using an elongation anticatalyst, if desired. Specific examples of the elongation anticatalyst include monoamines such as diethyle amine, dibutyl amine, butyl amine and lauryl amine, and blocked amines, i.e., ketimine compounds prepared by blocking the monoamines mentioned above.

The mixing ratio (i.e., a ratio [NCO]/[NHx]) of the content of the prepolymer (A) having an isocyanate group to the amine (B) is from 1/2 to 2/1, preferably from 1.5/1 to 1/1.5 and more preferably from 1.2/1 to 1/1.2. When the mixing ratio is greater than 2 or less than 1/2, molecular weight of the urea-modified polyester decreases, resulting in deterioration of hot offset resistance of the resultant toner.

A polyester resin preferably used in the present invention is a urea-modified polyester (UMPE), and the UMPE may include an urethane bonding as well as a urea bonding. The molar ratio (urea/urethane) of the urea bonding to the urethane bonding is from 100/0 to 10/90, preferably from 80/20 to 20/80 and more preferably from 60/40 to 30/70. When the content of the urea bonding is less than 10%, hot offset resistance of the resultant toner deteriorates.

The modified polyester such as the UMPE can be produced by a method such as a one-shot method. The weight-average molecular weight of the modified polyester of the UMPE is not less than 10,000, preferably from 20,000 to 10,000,000 and more preferably from 30,000 to 1,000,000. When the weight-average molecular weight is less than 10,000, hot offset resistance of the resultant toner deteriorates. The number-average molecular weight of the modified polyester of the UMPE is not particularly limited when the after-mentioned an unmodified polyester resin (PE) is used in combination. Namely, the weight-average molecular weight of the UMPE resins has priority over the number-average molecular weight thereof. However, when the UMPE is used alone, the number-average molecular weight is from 2,000 to 15,000, preferably from 2,000 to 10,000 and more preferably from 2,000 to 8,000. When the number-average molecular weight is greater than 20,000, the low temperature fixability of the resultant toner deteriorates, and in addition the glossiness of full color images deteriorates.

In the present invention, not only the modified polyester of the UMPE alone but also the PE can be included as a toner binder with the UMPE. A combination thereof improves low temperature fixability of the resultant toner and glossiness of color images produced thereby, and the combination is more preferably used than using the UMPE alone. Suitable PE includes polycondensation products of PO and PC similarly to the UMPE and specific examples of the PE are the same as those of the UMPE. The PE preferably has a weight-average particle diameter (Mw) of from 10,000 to 300,000, and more preferably from 14,000 to 200,000. In addition, the PE preferably has a number-average particle diameter of from 1,000 to 10,000, and more preferably from 1,500 to 6,000. In addition, for the UMPE, not only the unmodified polyester but also polyester resins modified by a bonding such as urethane bonding other than a urea bonding, can also be used together. It is preferable that the UMPE at least partially mixes with the PE to improve the low temperature fixability and hot offset resistance of the resultant toner. Therefore, the UMPE preferably has a structure similar to that of the PE. A mixing ratio (UMPE/PE) between the UMPE and PE is from 5/95 to 80/20, preferably from 5/95 to 30/70, more preferably from 5/95 to 25/75, and even more preferably from 7/93 to 20/80. When the UMPE is less than 5%, the hot offset resistance deteriorates, and in addition, it is disadvantageous to have both high temperature preservability and low temperature fixability.

The PE preferably has a hydroxyl value not less than 5 mg KOH/g and an acid value of from 1 to 30 mg KOH/g, and more preferably from 5 to 20 mg KOH/g. Such PE tends to be negatively charged, and the resultant toner has good affinity with a paper and low temperature fixability thereof is improved. However, when the acid value is greater than 30 mg KOH/g, chargeability of the resultant toner deteriorates particularly due to an environmental variation. In a polyaddition reaction, a variation of the acid value causes a crush of particles in a granulation process and it is difficult to control emulsifying.

The hydroxyl value is measured similarly to the method of measuring the acid value.

Precisely-weighed 0.5 g of a sample is placed in a volumetric flask, and precisely-measured 5 ml of an acetylated reagent is added thereto to prepare a mixture. The mixture is heated whiled dipped in an oil bath having a temperature at 100±5° C. One to two hrs later, the flask is taken out of the oil bath and left to cool. Water is added to the mixture, and the mixture is shaken to breakdown an acetic anhydride. The flask is heated again in an oil bath to complete the breakdown for not less than 10 min. After left and cooled, the inner wall of the flask is washed with an organic solvent. The mixture is subjected to a potentiometric titration with a N/2 potassium hydroxide ethyl alcohol solution using the above-mentioned electrode according to JIS K0070-1966.

In the present invention, the toner binder preferably has a glass transition temperature (Tg) of from 40 to 70° C., and preferably from 40 to 60° C. When the glass transition temperature is less than 40° C., the heat resistance of the toner deteriorates. When higher than 70° C., the low temperature fixability deteriorates. Because of a combination of the modified polyester such as UMPE and PE, the toner of the present invention has better heat-resistant preservability than known toners including a polyester resin as a binder resin even though the glass transition temperature is low.

A wax for use in the toner of the present invention has a low melting point of from 50 to 120° C. When such a wax is included in the toner, the wax is dispersed in the binder resin and serves as a release agent at a location between a fixing roller and the toner particles. Thereby, hot offset resistance can be improved without applying an oil to the fixing roller used.

In the present invention, the melting point of the wax is a maximum heat absorption peak measured by a differential scanning calorimeter (DSC).

Specific examples of the release agent include natural waxes such as vegetable waxes, e.g., carnauba wax, cotton wax, Japan wax and rice wax; animal waxes, e.g., bees wax and lanolin; mineral waxes, e.g., ozokelite and ceresine; and petroleum waxes, e.g., paraffin waxes, microcrystalline waxes and petrolatum. In addition, synthesized waxes can also be used. Specific examples of the synthesized waxes include synthesized hydrocarbon waxes such as Fischer-Tropsch waxes and polyethylene waxes; and synthesized waxes such as ester waxes, ketone waxes and ether waxes. In addition, fatty acid amides such as 1,2-hydroxylstearic acid amide, stearic acid amide and phthalic anhydride imide; and low molecular weight crystalline polymers such as acrylic homopolymer and copolymers having a long alkyl group in their side chain, e.g., poly-n-stearyl methacrylate, poly-n-laurylmethacrylate and n-stearyl acrylate-ethyl methacrylate copolymers, can also be used.

Specific examples of the colorant for use in the present invention include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials are used alone or in combination. The toner particles preferably include the colorant in an amount of from 1 to 15% by weight, and more preferably from 3 to 10% by weight.

The colorant for use in the present invention can be used as a master batch pigment when combined with a resin.

Specific examples of the resin for use in the master batch pigment or for use in combination with master batch pigment include the modified and unmodified polyester resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutylmethacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins are used alone or in combination.

The master batch for use in the toner of the present invention is typically prepared by mixing and kneading a resin and a colorant upon application of high shear stress thereto. In this case, an organic solvent can be used to heighten the interaction of the colorant with the resin. In addition, flushing methods in which an aqueous paste including a colorant is mixed with a resin solution of an organic solvent to transfer the colorant to the resin solution and then the aqueous liquid and organic solvent are separated and removed can be preferably used because the resultant wet cake of the colorant can be used as it is. Of course, a dry powder which is prepared by drying the wet cake can also be used as a colorant. In this case, a three-roll mill is preferably used for kneading the mixture upon application of high shear stress.

In the present invention, a charge controlling agent is fixed on the surface of the toner particles, for example, by the following method. Toner particles including at least a resin and a colorant are mixed with particles of a release agent in a container using a rotor. In this case, it is preferable that the container does not have a portion projected from the inside surface of the container, and the peripheral velocity of the rotor is preferably from 40 to 150 m/sec.

The toner of the present invention may optionally include a charge controlling agent. Specific examples of the charge controlling agent include any known charge controlling agents such as Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, salicylic acid derivatives, etc. Specific examples of the marketed products of the charge controlling agents include BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, a quaternary ammonium group, etc.

The content of the charge controlling agent is determined depending on the species of the binder resin used, whether or not an additive is added and toner manufacturing method (such as dispersion method) used, and is not particularly limited. However, the content of the charge controlling agent is typically from 0.1 to 10 parts by weight, and preferably from 0.2 to 5 parts by weight, per 100 parts by weight of the binder resin included in the toner. When the content is too high, the toner has too large charge quantity, and thereby the electrostatic force of a developing roller attracting the toner increases, resulting in deterioration of the fluidity of the toner and decrease of the image density of toner images. These charge controlling agent and release agent can be kneaded together with a master batch pigment and resin. In addition, the charge controlling agent and release agent can be added when such toner constituents are dissolved or dispersed in an organic solvent.

The toner binder of the present invention can be prepared, for example, by the following method. Polyol (PO) and

polycarboxylic acid (PC) are heated at a temperature of from 150 to 280° C. in the presence of a known catalyst such as tetrabutoxy titanate and dibutyltinoxide. Then, water generated is removed, under a reduced pressure if desired, to prepare a polyester resin having a hydroxyl group. Then the polyester resin is reacted with polyisocyanate (PIC) at a temperature of from 40 to 140° C. to prepare a prepolymer (A) having an isocyanate group. Further, the prepolymer (A) is reacted with an amine (B) at a temperature of from 0 to 140° C. to prepare a urea-modified polyester (UMPE). The UMPE has a number-average molecular weight of from 1,000 to 10,000, and preferably from 1,500 to 6,000. When polyisocyanate, and A and B are reacted, a solvent can be used if desired. Suitable solvents include solvents which do not react with polyisocyanate (PIC). Specific examples of such solvents include aromatic solvents such as toluene and xylene; ketones such as acetone, methyl ethyl ketone and methyl isobutyl ketone; esters such as ethyl acetate; amides such as dimethylformamide and dimethylacetoaminde; ethers such as tetrahydrofuran. When polyester which does not have a urea bonding (PE) is used in combination with the urea-modified polyester, a method similar to a method for preparing a polyester resin having a hydroxyl group is used to prepare the polyester which does not have a urea bonding, and the polyester which does not have a urea bonding is dissolved and mixed in a solution after a reaction of the UMPE is completed.

The toner of the present invention can be prepared by the following method, but the method is not limited thereto.

The aqueous medium for use in the present invention includes water alone and mixtures of water with a solvent which can be mixed with water. Specific examples of the solvent include alcohols such as methanol, isopropanol and ethylene glycol; dimethylformamide; tetrahydrofuran; cellosolves such as methyl cellosolve; and lower ketones such as acetone and methyl ethyl ketone.

The toner of the present invention can be prepared by reacting a dispersion formed of the prepolymer (A) having an isocyanate group with (B). As a method of stably preparing a dispersion formed of the urea-modified polyester or the prepolymer (A) in an aqueous medium, a method of including toner constituents such as the urea-modified polyester or the prepolymer (A) into an aqueous medium and dispersing them upon application of shear stress is preferably used. The prepolymer (A) and other toner constituents such as colorants, master batch pigments, release agents, charge controlling agents, unmodified polyester resins, etc. may be added into an aqueous medium at the same time when the dispersion is prepared. However, it is preferable that the toner constituents are previously mixed and then the mixed toner constituents are added to the aqueous liquid at the same time. In addition, colorants, release agents, charge controlling agents, etc., are not necessarily added to the aqueous dispersion before particles are formed, and may be added thereto after particles are prepared in the aqueous medium. A method of dyeing particles previously formed without a colorant by a known dying method can also be used.

The dispersion method is not particularly limited, and low speed shearing methods, high-speed shearing methods, friction methods, high-pressure jet methods, ultrasonic methods, etc. can be used. Among these methods, high-speed shearing methods are preferably used because particles having a particle diameter of from 2 to 20 μm can be easily prepared. At this point, the particle diameter (2 to 20 μm) means a particle diameter of particles including a liquid). When a high-speed shearing type dispersion machine is used, the rotation speed is not particularly limited, but the rotation speed is typically from 1,000 to 30,000 rpm, and preferably from 5,000 to 20,000 rpm. The dispersion time is not also particularly limited, but is typically from 0.1 to 5 minutes. The temperature in the dispersion process is typically from 0 to 15° C. (under pressure), and preferably from 40 to 98° C. When the temperature is relatively high, the urea-modified polyester or prepolymer (A) can easily be dispersed because the dispersion formed thereof has a low viscosity.

The content of the aqueous medium to 100 parts by weight of the toner constituents including the urea-modified polyester or prepolymer (A) is typically from 50 to 2,000 parts by weight, and preferably from 100 to 1,000 parts by weight. When the content is less than 50 parts by weight, the dispersion of the toner constituents in the aqueous medium is not satisfactory, and thereby the resultant mother toner particles do not have a desired particle diameter. In contrast, when the content is greater than 2,000, the production cost increases. A dispersant can preferably be used to prepare a stably dispersed dispersion including particles having a sharp particle diameter distribution.

Specific examples of the dispersants used to emulsify and disperse an oil phase for a liquid including water in which the toner constituents are dispersed include anionic surfactants such as alkylbenzene sulfonic acid salts, α-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants such as fatty acid amide derivatives, polyhydric alcohol derivatives; and ampholytic surfactants such as alanine, dodecyldi(aminoethyl)glycin, di(octylaminoethyle)glycin, and N-alkyl-N,N-dimethylammonium betaine.

A surfactant having a fluoroalkyl group can prepare a dispersion having good dispersibility even when a small amount of the surfactant is used. Specific examples of anionic surfactants having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4)sulfonate, sodium-{omega-fluoroalkanoyl(C6-C8)-N-ethylamino}-1-propane sulfonate, fluoroalkyl(C11-C20)carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonyl glycin, monoperfluoroalkyl(C6-C16)ethylphosphates, etc.

Specific examples of the marketed products of such surfactants having a fluoroalkyl group include SURFLON S-111, S-112 and S-113, which are manufactured by Asahi Glass Co., Ltd.; FRORARD FC-93, FC-95, FC-98 and FC-129, which are manufactured by Sumitomo 3M Ltd.; UNIDYNE DS-101 and DS-102, which are manufactured by Daikin Industries, Ltd.; MEGAFACE F-110, F-120, F-113, F-191, F-812 and F-833 which are manufactured by Dainippon Ink and Chemicals, Inc.; ECTOP EF-102, 103, 104, 105, 112, 123A, 306A, 501, 201 and 204, which are manufactured by Tohchem Products Co., Ltd.; FUTARGENT F-100 and F150 manufactured by Neos; etc.

Specific examples of the cationic surfactants, which can disperse an oil phase including toner constituents in water, include primary, secondary and tertiary aliphatic amines having a fluoroalkyl group, aliphatic quaternary ammonium salts such as erfluoroalkyl(C6-C10)sulfoneamidepropyltrimethylammonium salts, benzalkonium salts, benzetonium chloride, pyridinium salts, imidazolinium salts, etc. Specific examples of the marketed products thereof include SURFLON S-121 (from Asahi Glass Co., Ltd.); FRORARD FC-135 (from Sumitomo 3M Ltd.); UNIDYNE DS-202 (from Daikin Industries, Ltd.); MEGAFACE F-150 and F-824 (from Dainippon Ink and Chemicals, Inc.); ECTOP EF-132 (from Tohchem Products Co., Ltd.); FUTARGENT F-300 (from Neos); etc.

In addition, inorganic compound dispersants such as tricalcium phosphate, calcium carbonate, titanium oxide, colloidal silica and hydroxyapatite which are hardly insoluble in water can also be used.

In addition, particulate polymers can also be used as a dispersant as well as inorganic dispersants such as calcium phosphate, sodium carbonate and sodium sulfate. Specific examples of the particulate polymers include particulate polymethyl methacrylate having a particle diameter of 1 μm and 3 μm, particulate polystyrene having a particle diameter of 0.5 μm and 2 μm, particulate styrene-acrylonitrile copolymers having a particle diameter of 1 μm, PB-200H (from Kao Corp.), SGP (Soken Chemical & Engineering Co., Ltd.), TECHNOPOLYMER SB (Sekisui Plastics Co., Ltd.), SPG-3G (Soken Chemical & Engineering Co., Ltd.), and MICROPEARL (Sekisui Fine Chemical Co., Ltd.).

Further, it is possible to stably disperse toner constituents in water using a polymeric protection colloid in combination with the inorganic dispersants and/or particulate polymers mentioned above. Specific examples of such protection colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine). In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloid.

The prepared emulsion dispersion (reactant) is gradually heated while stirred in a laminar flow, and an organic solvent is removed from the dispersion after stirred strongly when the dispersion has a specific temperature to from a toner particle having a shape of spindle. When an acid such as calcium phosphate or a material soluble in alkaline is used as a dispersant, the calcium phosphate is dissolved with an acid such as a hydrochloric acid and washed with water to remove the calcium phosphate from the toner particle. Besides this method, it can also be removed by an enzymatic hydrolysis.

When a dispersant is used, the dispersant may remain on a surface of the toner particle.

Further, in order to decrease viscosity of a dispersion medium including the toner constituents, a solvent which can dissolve the UMPE or prepolymer (A) can be used because the resultant particles have a sharp particle diameter distribution.

The solvent is preferably volatile and has a boiling point lower than 100° C. because of easily removed from the dispersion after the particles are formed. Specific examples of such a solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, etc. These solvents can be used alone or in combination. Among these solvents, aromatic solvents such as toluene and xylene; and halogenated hydrocarbons such as methylene chloride, 1,2-dichloroethane, chloroform, and carbon tetrachloride are preferably used. The addition quantity of such a solvent is from 0 to 300 parts by weight, preferably from 0 to 100, and more preferably from 25 to 70 parts by weight, per 100 parts by weight of the prepolymer (A) used. When such a solvent is used to prepare a particle dispersion, the solvent is removed therefrom under a normal or reduced pressure after the particles are subjected to an elongation reaction and/or a cross linking reaction of the modified polyester (prepolymer) with amine.

The elongation and/or crosslinking reaction time depend on reactivity of an isocyanate structure of the prepolymer (A) and amine (B), but is typically from 10 min to 40 hrs, and preferably from 2 to 24 hrs. The reaction temperature is typically from 0 to 150° C., and preferably from 40 to 98° C. In addition, a known catalyst such as dibutyltinlaurate and dioctyltinlaurate can be used.

In the present invention, a solvent is preferably removed from the dispersion liquid after the elongation and/or crosslinking reaction at 10 to 50° C. after it is strongly stirred at a specific temperature lower than the glass transition temperature of the resin and an organic solvent concentration to form and see particles, which deforms the toner. This is not an absolute condition and the condition has to be properly controlled. When an organic solvent concentration is high in granulating, the viscosity of the emulsion decreases and the particles are likely to have the shape of a sphere. When low, the viscosity thereof is high and the particles have shapes out of specification. Therefore, the condition has to be optimally controlled, and which controls the shape of a toner. Further, the content of the modified layered inorganic mineral controls the shape of a toner. The modified layered inorganic mineral is preferably included in a solution or a dispersion in an amount of from 0.05 to 10% by weight. When less than 0.05% by weight, the oil phase does not have a desired viscosity and the particles do not have desired shapes. In addition, the viscosity of the droplet decreases and the particles are likely to have the shape of a sphere. When greater than 10% by weight, the viscosity of the droplet is so high that particles are not formed.

On the other hand, a ratio (Dv/Dn) between a volume-average particle diameter (Dv) and a number-average particle diameter (Dn) of the toner can be fixed by controlling a water layer viscosity, an oil layer viscosity, properties of resin particles, addition quantity thereof, etc. In addition, Dv and Dn can be fixed by controlling the properties of resin particles, addition quantity thereof, etc.

The toner of the present invention can be used for a two-component developer in which the toner is mixed with a magnetic carrier. A content of the toner is preferably from 1 to 10 parts by weight per 100 parts by weight of the carrier. Suitable carriers for use in the two component developer include known carrier materials such as iron powders, ferrite powders, magnetite powders, magnetic resin carriers, which have a particle diameter of from about 20 to 200 μm. A surface of the carrier may be coated by a resin. Specific examples of such resins to be coated on the carriers include amino resins such as urea-formaldehyde resins, melamine resins, benzoguanamine resins, urea resins, and polyamide resins, and epoxy resins. In addition, vinyl or vinylidene resins such as acrylic resins, polymethylmethacrylate resins, polyacrylonitirile resins, polyvinyl acetate resins, polyvinyl alcohol resins, polyvinyl butyral resins, polystyrene resins, styrene-acrylic copolymers, halogenated olefin resins such as polyvinyl chloride resins, polyester resins such as polyethyleneterephthalate resins and polybutyleneterephthalate resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, copolymers of tetrafluoroethylene, vinylidenefluoride and other monomers including no fluorine atom, and silicone resins. An electroconductive powder may optionally be included in the toner. Specific examples of such electroconductive powders include metal powders, carbon blacks, titanium oxide, tin oxide, and zinc oxide. The average particle diameter of such electroconductive powders is preferably not greater than 1 μm. When the particle diameter is too large, it is hard to control the resistance of the resultant toner.

The toner of the present invention can also be used as a one-component magnetic developer or a one-component non-magnetic developer.

The image forming apparatus of the present invention uses the toner of the present invention, and the other constitutions are same as those of a conventional image forming apparatus. The image forming apparatus of the present invention includes at least an electrostatic latent image bearer, an electrostatic latent image former, an image developer, a transferer, and a fixer, and optionally includes other means such as a discharger, a cleaner, a recycler and a controller.

The image forming method of the present invention uses the toner of the present invention, and the other constitutions are same as those of a conventional image forming method. The image forming method of the present invention includes at least electrostatic latent image forming process; a developing process, a transferring process, and a fixing process. The image forming method optionally includes other processes such as a discharging process, a cleaning process, a toner recycling process and a controlling process. Particularly, the toner of the present invention is preferably used in an image forming method using an image developer having a toner recycler.

A toner container containing the toner of the present invention is not particularly limited, and the toner container is preferably selected from known containers such as a container having a cap. The container may have a size, a shape, a structure, a material, etc. in accordance with the purpose. The container preferably has a cylindrical shape and spiral concavities and convexities on the inner circumferential face, and a part or all of which are accordion. Such a container transfers a toner therein to a discharge outlet thereof when rotated. The container is preferably formed of a material having good size preciseness, such as a polyester resin, polyethylene, polypropylene, polystyrene, polyvinylchloride, polyacrylate, a polycarbonate resin, an ABS resin and polyacetal resin. The developer container of the present invention is easy to store, transport and handle, and detachable from a process cartridge and an image forming apparatus to feed a developer thereto.

The process cartridge of the present invention includes at least an image bearer bearing an electrostatic latent image and an image developer developing the electrostatic latent image borne by the image bearer with a developer to form a visible image, and further includes other means optionally, such as a charger, a transferer, a cleaner, a discharger. The image developer includes at least a developer container containing the developer of the present invention and a developer bearer bearing and transferring the developer contained in the developer container, and optionally includes a layer regulator regulating a toner layer borne on the surface of the developer bearer. The process cartridge of the present invention is detachably installable in various electrophotographic image forming apparatuses, facsimiles and printers, and is preferably installed in the image forming apparatus detachably.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

The following external additives were used in Examples and Comparative Examples:

(A) a particulate hydrophobic silica having a primary particle diameter of 12 nm

(B) a particulate hydrophobic titanium oxide having a primary particle diameter of 15 nm

(C) a particulate hydrophobic silica having a primary particle diameter of 120 nm and an aspect ratio of 0.88

(D) a particulate hydrophobic titanium oxide having a primary particle diameter of 80 nm and an aspect ratio of 0.70

(E) a particulate hydrophobic silica having a primary particle diameter of 130 nm and an aspect ratio of 0.98 and

(F) a particulate hydrophobic titanium oxide having a primary particle diameter of 80 nm and an aspect ratio of 0.65.

### Example 1

229 parts of an adduct of bisphenol A with 2 moles of ethyleneoxide, 529 parts of an adduct of bisphenol A with 3 moles of propyleneoxide, 208 parts terephthalic acid, 46 parts of adipic acid and 2 parts of dibutyltinoxide were polycondensated in a reactor vessel including a cooling pipe, a stirrer and a nitrogen inlet pipe for 8 hrs at a normal pressure and 230° C. Further, after the mixture was depressurized by 10 to 15 mm Hg and reacted for 5 hrs, 44 parts of trimellitic acid anhydride were added thereto and the mixture was reacted for 2 hrs at a normal pressure and 180° C. to prepare an unmodified polyester resin. The unmodified polyester resin had a number-average molecular weight of 2,500, a weight-average molecular weight of 6,700, a Tg of 43° C. and an acid value of 25 mg KOH/g.

1,200 parts of water, 540 parts of carbon black Printex 35 from Degussa A.G. having a DBP oil absorption of 42 ml/100 mg and a pH of 9.5, 1,200 parts of the unmodified polyester resin were mixed by a Henschel mixer from Mitsui Mining Co., Ltd. After the mixture was kneaded by a two-roll mill having a surface temperature of 110° C. for 1 hr, the mixture was extended by applying pressure, cooled and pulverized by a pulverizer from Hosokawa Micron Limited to prepare a master batch.

378 parts of the unmodified polyester resin, 110 parts of carnauba wax, 22 parts of a metal complex of salicylic acid E-84 from Orient Chemical Industries Co., Ltd. and 947 parts of ethyl acetate were mixed in a reaction vessel including a stirrer and a thermometer. The mixture was heated to have a temperature of 80° C. while stirred. After the temperature of 80° C. was maintained for 5 hrs, the mixture was cooled to have a temperature of 30° C. in an hour. Then, 500 parts of the master batch 1 and 500 parts of ethyl acetate were added to the mixture and mixed for 1 hr to prepare a material solution.

1,324 parts of the material solution were transferred into another vessel, and the carbon black and wax therein were dispersed by a beads mill (Ultra Visco Mill from IMECS CO., LTD.) for 3 passes at a liquid feeding speed of 1 kg/hr and a peripheral disc speed of 6 m/sec using zirconia beads having diameter of 0.5 mm for 80% by volume to prepare a wax dispersion.

Next, 1,324 parts of an ethyl acetate solution of the unmodified polyester resin having a concentration of 65% were added to the wax dispersion. 3 parts of layered in organic mineral montmorillonite, at least a part of which is modified with a quaternary ammonium salt having a benzyl group, Clayton APA from Southern Clay Products, Inc. were added to 200 parts of the wax dispersion subjected to one pass using the Ultra Visco Mill under the same conditions to prepare a mixture. The mixture was stirred for 30 min with T.K. Homodisper from Tokushu Kika Kogyo Co., Ltd. to prepare a toner constituents dispersion.

682 parts of an adduct of bisphenol A with 2 moles of ethyleneoxide, 81 parts of an adduct of bisphenol A with 2 moles of propyleneoxide, 283 parts terephthalic acid, 22 parts of trimellitic acid anhydride and 2 parts of dibutyltinoxide were mixed and reacted in a reactor vessel including a cooling pipe, a stirrer and a nitrogen inlet pipe for 7 hrs at a normal pressure and 230° C. Further, after the mixture was depressurized by 10 to 15 mm Hg and reacted for 5 hrs to prepare an intermediate polyester resin.

The intermediate polyester resin had a number-average molecular weight of 2,100, a weight-average molecular weight of 9,500, a Tg of 55° C. and an acid value of 0.5 mg KOH/g and a hydroxyl value of 51 mg KOH/g.

Next, 410 parts of the intermediate polyester resin, 89 parts of isophoronediisocyanate and 500 parts of ethyl acetate were reacted in a reactor vessel including a cooling pipe, a stirrer and a nitrogen inlet pipe for 5 hrs at 100° C. to prepare a prepolymer. The prepolymer included a free isocyanate in an amount of 1.53% by weight.

170 parts of isophoronediamine and 75 parts of methyl ethyl ketone were reacted at 50° C. for 5 hrs in a reaction vessel including a stirrer and a thermometer to prepare a ketimine compound. The ketimine compound had an amine value of 418 mg KOH/g.

749 parts of the toner constituents dispersion, 115 parts of the prepolymer and 2.9 parts of the ketimine compound were mixed in a vessel by a TK-type homomixer from Tokushu Kika Kogyo Co., Ltd. at 5,000 rpm for 1 min to prepare an oil phase mixed liquid.

683 parts of water, 11 parts of a sodium salt of an adduct of a sulfuric ester with ethyleneoxide methacrylate (ELEMINOL RS-30 from Sanyo Chemical Industries, Ltd.), 83 parts of styrene, 83 parts of methacrylate, 110 parts of butylacrylate and 1 part of persulfate ammonium were mixed in a reactor vessel including a stirrer and a thermometer, and the mixture was stirred for 15 min at 400 rpm to prepare a white emulsion therein. The white emulsion was heated to have a temperature of 75° C. and reacted for 5 hrs. Further, 30 parts of an aqueous solution of persulfate ammonium having a concentration of 1% were added thereto and the mixture was reacted for 5 hrs at 75° C. to prepare a particulate resin dispersion.

In the present invention, the toner dispersion diameter and the dispersion diameter distribution were measured with MICROTRAC UPS-150 from NIKKISO CO., LTD., and analyzed with a analysis software MICROTRAC particle size analyzer Ver. 10.1.2-016EE from NIKKISO CO., LTD. Specifically, the toner constituents dispersion was placed in a glass sample bottle having a capacity of 30 ml and the solvent used for preparing the toner constituents dispersion was added thereto to prepare a dispersion including the toner constituents in an amount of 10% by weight. The dispersion was dispersed for 2 min by an ultrasonic disperser W-113MK-II from HONDA ELECTRONICS CO., LTD.

After the background was measured with the solvent used for preparing the toner constituents dispersion, the dispersion was subjected to instillation and the dispersion particle diameter was measured such that a sample loading value of the UPS-150 was from 1 to 10. This is essential in terms of measurement reproducibility of the dispersion particle diameter. The dropping amount of the dispersion needs controlling to obtain the sample loading value.

The measurement and analysis conditions are as follows.

Distribution display: volume

Particle diameter classification selection: standard

The number of channels: 44

Measurement time: 60 sec

The number of measurement: once

Particle permeability: permeable

Particle flexibility: 1.5

Particle form: nonspheric

Density: 1 g/cm³

A value of the solvent used for preparing the toner constituents dispersion, which is described in “Guideline on Input Conditions in Measurement” published by NIKKISO CO., LTD. was used as a value of the solvent flexibility.

990 parts of water, 83 parts of the [particulate dispersion liquid 1], 37 parts of an aqueous solution of sodium dodecyldiphenyletherdisulfonate having a concentration of 48.5% (ELEMINOL MON-7 from Sanyo Chemical Industries, Ltd.), 135 parts of an aqueous solution having a concentration of 1% by weight of a polymer dispersant carboxymethylcellulose sodium Selogen BS-H-3 from DAI-ICHI KOGYO SEIYAKU CO., LTD. and 90 parts of ethyl acetate were mixed and stirred to prepare an aqueous medium.

867 parts of the oil phase mixed liquid was added to 1,200 parts of the aqueous medium and mixed therewith by a TK-type homomixer at 13,000 rpm for 20 min to prepare an emulsion slurry.

The emulsion slurry was placed in a vessel including a stirrer and a thermometer. After a solvent was removed from the emulsion slurry at 30° C. for 8 hrs, it was aged at 45° C. for 4 hrs to prepare a dispersion slurry.

After the dispersion slurry was filtered under reduced pressure, 100 parts of ion-exchange water were added to the resultant filtered cake and mixed by the TK-type homomixer at 12,000 rpm for 10 min, and the mixture was filtered.

A hydrochloric acid having a concentration of 10% by weight was added to the filtered cake to have a pH of 2.8 and mixed by the TK-type homomixer at 12,000 rpm for 10 min, and the mixture was filtered.

Further, 300 parts of ion-exchange water were added to the filtered cake and mixed by the TK-type homomixer at 12,000 rpm for 10 min, and the mixture was filtered twice to prepare a final filtered cake.

The final filtered cake was dried by an air drier at 45° C. for 48 hrs and sieved by a mesh having an opening of 75 μm to prepare a parent toner particle. Then, 1.0 part of the external additive (A), 0.5 parts of the external additive (B) and further 1.0 part of the external additive (C) was added to the parent toner particle and the mixture was mixed by a Henschel mixer at a peripheral speed of 33 m/s for 5 min to prepare a toner powder. The toner powder was filtered through a mesh having an opening of 100 μm to remove a coarse powder. Thus, a toner was prepared.

### Example 2

The procedure for preparation of the toner in Example 1 was repeated to prepare a toner except for replacing the external additive (C) with the external additive (D).

### Comparative Example 1

The procedure for preparation of the toner in Example 1 was repeated to prepare a toner except for replacing the external additive (C) with the external additive (E).

### Comparative Example 2

The procedure for preparation of the toner in Example 1 was repeated to prepare a toner except for replacing the external additive (C) with the external additive (F).

### Comparative Example 3

The procedure for preparation of the toner in Example 1 was repeated to prepare a toner except for not adding the external additive (C) to the parent toner particle.

The volume-average particle diameter Dv, number-average particle diameter, particle diameter distribution Dv/Dn, average circularity, shape factor SF-1 and cleanability of the toner were measured as follows.

The Dv and Dn were measured by Multisizer III from Beckman Coulter, Inc. using an aperture of 100 μm. An analysis software Beckman Multisizer 3 Version 3.51 was used. Specifically, 0.5 g of the toner and 0.5 ml of a surfactant (alkylbenzenesulfonate Neogen SC-A from Dai-ichi Kogyo Seiyaku Co., Ltd.) having a concentration of 10% by weight were mixed with a micro spatel in a glass beaker having a capacity of 100 ml, and 80 ml of ion-exchange water was added to the mixture. The mixture was dispersed by an ultrasonic disperser W-113MK-II from HONDA ELECTRONICS CO., LTD. for 10 min. The dispersion was measure by Multisizer III using ISOTON III as a measurement solution from Beckman Coulter, Inc. The dispersion was dropped such that Multisizer III displays a concentration of 8±2%, which is essential in terms of measurement reproducibility of the particle diameter. The particle diameter has no accidental error in the range of the concentration.

In the present invention, the circularity of the toner is measured by FPIA-2100 from SYSMEX CORPORATION and an analysis software FPIA-2100 Data Processing Program for FPIA version 00-10 was used. Specifically, 0.1 to 0.5 g of the toner and 0.5 ml of a surfactant (alkylbenzenesulfonate Neogen SC-A from Dai-ichi Kogyo Seiyaku Co., Ltd.) having a concentration of 10% by weight were mixed with a micro spatel in a glass beaker having a capacity of 100 ml, and 80 ml of ion-exchange water was added to the mixture. The mixture was dispersed by an ultrasonic disperser W-113MK-II from HONDA ELECTRONICS CO., LTD. for 3 min. The circularity of the toner was measured by FPIA-2100 until the dispersion has a concentration of from 5,000 to 15,000 pieces/μl, which is essential in terms of measurement reproducibility of the average circularity. In order to obtain the concentration, it is necessary to control added amounts of the surfactant and the toner. The amount of the surfactant depends on the hydrophobicity of the toner. When too much, bubbles cause noises. When short, the toner is not sufficiently wetted and not sufficiently dispersed. The amount of the toner depends on the particle diameter thereof. When small, the amount needs to be less. When large, the amount needs to be more. When the toner has a particle diameter of from 3 to 7 μm, the amount thereof is 0.1 to 0.5 g such that the dispersion has a concentration of from 5,000 to 15,000 pieces/μl.

SF-1 was measured as follows. 100 or more toners were observed using an FE-SEM (S-5200) from Hitachi, Ltd. at an accelerating voltage of 2.5 keV after deposited with a metal. Next, SF-1 was determined using an image analyzer Luzex AP and image processing software from NIRECO Corp.

Cleanability was evaluated as follows. A residual toner on a photoreceptor after cleaned was transferred with a Scotch Tape from Sumitomo 3M Ltd. onto a white paper at the beginning, after 1,000 and after 100,000 images were produced. Density of the white paper was measured by Macbeth reflection densitometer RD514. When a density difference between the white paper the residual toner was transferred to and a blank white paper was not greater than 0.01, the cleanability was determined as good (◯). When greater than 0.01, the cleanability was determined as poor (×).

The fixability of the toner was evaluated as follows. imagio Neo 450 from Ricoh Company, Ltd., modified to have a belt heating fixer was used. The belt includes a substrate formed of polyimide 100 μm thick, an intermediate elastic layer formed of a silicon rubber 100 μm thick and an anti-offset surface layer formed of PFA 15 μm thick. The fixing roller is formed of a silicon foam. The pressure roller includes a metallic cylinder formed of SUS 1 mm thick and an anti-offset layer formed of PFA tube and silicon rubber 2 mm thick. The heat roller is formed of aluminum having a thickness of 2 mm and a surface pressure of 1×10⁵ Pa.

A minimum fixable temperature and a hot offset temperature were measured. The minimum fixable temperature was determined as a temperature at which an image did not peel. Conventional toners have a minimum fixable temperature of from 140 to 150° C. Conditions of evaluating the minimum fixable temperature included a paper feeding linear speed of from 120 to 150 mm/sec, a surface pressure of 1.2 Kgf/cm² and a nip width of 3 mm. Conditions of evaluating the hot offset temperature included a paper feeding linear speed of 50 mm/sec, a surface pressure of 2.0 Kgf/cm² and a nip width of 4.5 mm. The evaluations are based on the following standards.

### (1) A Minimum Fixable Temperature (5 Grades)

⊚: less than 120° C.

◯: 120 to 130° C.

□: 130 to 140° C.

Δ: 140 to 150° C.

×: 150° C. or higher

### (2) Hot Offset Temperature

⊚: 201° C. or higher

◯: 200 to 191° C.

□: 190 to 181° C.

Δ: 180 to 171° C.

×: 170° C. or lower

### (Image Density)

After 150,000 images of an image chart having an image area of 50% were produced in a monochrome mode by a digital full-color copier imagio Color 2800 from Ricoh Company, Ltd., a solid image was produced on a Ricoh 6000 paper from Ricoh Company, Ltd., and the image density was measured by X-Rite from X-Rite, Inc. 4 colors were independently produced and an average of their image densities was determined at 30° C. and 80% Rh (HH environment) and 10° C. and 15% Rh (LL environment).

⊚: 1.8 to less than 2.2

◯: 1.4 to less than 1.8

Δ: 1.2 to less than 1.4

×: less than 1.2

### (Transferability)

A residual toner on a photoreceptor just before cleaned was transferred with a Scotch Tape from Sumitomo 3M Ltd. onto a white paper after an image chat having an image area of 20% was produced. Density of the white paper was measured by Macbeth reflection densitometer RD514.

⊚: difference with blank less than 0.005

◯: difference with blank of from 0.05 to 0.010

Δ: difference with blank of from 0.011 to 0.02

×: difference with blank more than 0.02

The evaluation results are shown in Table 1.

TABLE 1

| | | | | | | Cl | | | | | ID | | |
|---|---|---|---|---|---|---|---|---|---|---|---|---|---|
| | Dv | Dn | Dv/Dn | AC | SF-1 | I | 1K | 100K | Fix. | HO | HH | LL | Tr. |
| Ex. 1 | 5.1 | 4.9 | 1.05 | 0.947 | 151 | ◯ | ◯ | ◯ | ⊚ | ⊚ | ◯ | ◯ | ⊚ |
| Ex. 2 | 5.1 | 4.9 | 1.05 | 0.947 | 151 | ◯ | ◯ | ◯ | ⊚ | ⊚ | ⊚ | ◯ | ⊚ |
| Com. | 5.1 | 4.9 | 1.05 | 0.947 | 151 | ◯ | ◯ | ◯ | ⊚ | ⊚ | ◯ | ◯ | X |
| Ex. 1 | | | | | | | | | | | | | |
| Com. | 5.1 | 4.9 | 1.05 | 0.947 | 151 | ◯ | ◯ | ◯ | ⊚ | ⊚ | ⊚ | ◯ | X |
| Ex. 2 | | | | | | | | | | | | | |
| Com. | 5.1 | 4.9 | 1.05 | 0.947 | 151 | X | X | X | ⊚ | ⊚ | ◯ | Δ | X |
| Ex. 3 | | | | | | | | | | | | | |

AC: average circularity
Cl: cleanability
I: initial
Fix.: fixability
HO: hot offset
ID: image density
Tr.: transferability

This proves that the toners of Examples have good cleanability and transferability from the beginning for long periods. The toner of Comparative Example 3 has poor cleanability and transferability from the beginning, and could not be evaluated for a long time.

This application claims priority and contains subject matter related to Japanese Patent Application No. 2007-069424 filed on Mar. 16, 2007, the entire contents of which are hereby incorporated by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner, comprising:
a binder resin;
a colorant; and
a modified layered inorganic mineral in which at least a part of ions between the layers are modified with an organic material ion,
wherein the toner comprises at least one external additive having an average primary particle diameter of from 80 to 180 nm and an aspect ratio of from 0.7 to 0.95.

2. The toner of claim 1, wherein the external additive is a member selected from the group consisting of a particulate silica, a particulate titanium oxide, a particulate alumina and an organic particulate material.

3. The toner of claim 1, wherein the toner comprises the external additive in an amount of from 0.01 to 5% by weight.

4. The toner of claim 1, wherein the toner has an average circularity of from 0.925 to 0.970.

5. The toner of claim 1, wherein the modified layered inorganic mineral is a modified layered inorganic mineral in which at least a part of cations between the layers are modified with an organic material cation.

6. The toner of claim 1, wherein the toner is prepared by a method comprising at least one of dispersing toner constituents comprising the modified layered inorganic mineral in an aqueous medium and emulsifying toner constituents comprising the modified layered inorganic mineral in an aqueous medium.

7. The toner of claim 1, wherein the toner is prepared by a method comprising:
dissolving or dispersing toner constituents comprising a first binder resin, a binder resin precursor, a compound elongatable or crosslinkable with the binder resin precursor, a colorant; a release agent, and the modified layered inorganic mineral in an organic solvent to prepare a solution or a dispersion;
subjecting the solution or the dispersion to at least one of a cross-linking reaction and an elongation reaction in an aqueous medium to prepare a reactant dispersion; and
removing the solvent from the reactant dispersion.

8. The toner of claim 7, wherein the first binder resin is a resin having a polyester skeleton.

9. The toner of claim 7, wherein the first binder resin is a polyester resin.

10. The toner of claim 9, wherein the polyester resin is an unmodified polyester resin.

11. The toner of claim 7, wherein the binder resin precursor is a modified polyester resin.

12. The toner of claim 7, wherein the binder resin precursor has a site reactable with a compound having an active hydrogen group and a weight-average molecular weight of from 3,000 to 20,000.

13. The toner of claim 1, wherein the toner has a ratio (Dv/Dn) of a volume-average particle diameter (Dv) to a number-average particle diameter (Dn) of from 1.00 to 1.30 and includes particles having a circularity not greater than 0.950 in an amount of 20 to 80% by number.

14. The toner of claim 1, wherein the toner has the ratio (Dv/Dn) of from 1.00 to 1.20.

15. The toner of claim 1, wherein the toner includes particles having a particle diameter not greater than 2 μm in an amount of not greater than 20% by number.

16. The toner of claim 1, wherein the toner has an acid value of from 0.5 to 40.0 KOH mg/g.

17. The toner of claim 1, wherein the toner has a glass transition temperature of from 40 to 70° C.

18. The toner of claim 1, wherein the toner is included in a two-component developer comprising a toner and a carrier.

19. A developer comprising the toner according to claim 1.

20. An image forming apparatus, comprising:
an image bearer configured to bear an image;
a charger configured to charge the image bearer;
an irradiator configured to from an electrostatic latent image thereon;
image developer configured to develop the electrostatic latent image with a developer comprising a toner to form a toner image on the image bearer;
a transferer configured to transfer the toner image onto a recording material; and
fixing the toner image on the recording material,
wherein the developer is the developer according to claim 19.
